(19) United States
(12) Patent Application Publication
(10) Pub. No.: US 2025/0051615 A1
(43) Pub. Date: Feb. 13, 2025

(54) EMBOSSED PVC TAPE

(71) Applicant: NAN YA PLASTICS CORPORATION, TAIPEI (TW)

(72) Inventors: TE-CHAO LIAO, TAIPEI (TW); HAO-SHENG CHEN, TAIPEI (TW); CHEN-WEI CHANG, TAIPEI (TW)

(21) Appl. No.: 18/475,221

(22) Filed: Sep. 27, 2023

(30) Foreign Application Priority Data
Aug. 10, 2023 (TW) 112130050

(51) Int. Cl. C09J 7/38; C09J 7/10

(52) U.S. Cl. CPC C09J 7/381; C09J 7/10; C09J 2301/408; C09J 2427/00

(57) ABSTRACT

An embossed PVC tape has a first surface and a second surface that are opposite to each other. The embossed PVC tape has an embossed texture formed on the first surface. The embossed texture includes a plurality of repeating patterns, and each of the repeating patterns includes a bottom portion arranged on the first surface and a side portion recessed in the first surface. The side portion has a tapered shape, and an end of the side portion away from the first surface is defined as an end point. On the first surface, a quantity of the end point formed per 3,000 square microns is one or more. A maximum static friction coefficient between the first surface and the second surface is within a range from 0.72 to 0.78.

### CROSS-REFERENCE TO RELATED PATENT APPLICATION

This application claims the benefit of priority to Taiwan Patent Application No. 112130050, filed on Aug. 10, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyvinyl chloride (PVC) tape, and more particularly to an embossed PVC tape.

### BACKGROUND OF THE DISCLOSURE

Generally, a conventional PVC tape is added with a lubricant or sprinkled with talcum powders, such that opposite surfaces of the PVC tape do not easily stick to each other. If the opposite surfaces of the PVC tape are too sticky, a stress of the PVC tape can be too large during a continuous printing process, thereby affecting the printing quality and causing a manufacturing speed to decrease.

However, addition of the lubricant affects a transparency of the PVC tape, thereby affecting the printing quality. In addition, the talcum powders may be unevenly dispersed in the PVC tape, which also affects the printing quality.

### SUMMARY OF THE DISCLOSURE

In response to the above-referenced technical inadequacies, the present disclosure provides an embossed PVC tape that possesses a specific comfortable property (i.e., two opposite surfaces of a PVC tape do not easily stick to each other or slide relative to each other) without sacrificing the printing quality.

In order to solve the above-mentioned problems, one of the technical aspects adopted by the present disclosure is to provide an embossed PVC tape, which has a first surface and a second surface that are opposite to each other. The embossed PVC tape has an embossed texture formed on the first surface. The embossed texture includes a plurality of repeating patterns, each of the repeating patterns includes a bottom portion arranged on the first surface and a side portion recessed in the first surface, the side portion has a tapered shape, and an end of the side portion away from the first surface is defined as an end point. On the first surface, a quantity of the end point formed per 3,000 square microns is one or more. A maximum static friction coefficient between the first surface and the second surface is within a range from 0.72 to 0.78.

In one of the possible or preferred embodiments, each of the repeating patterns has a triangular pyramid shape.

In one of the possible or preferred embodiments, a length of the bottom portion along a longitudinal direction is within a range from 50 μm to 55 μm, and a width of the bottom portion along a lateral direction is within a range from 58 μm to 62 μm.

In one of the possible or preferred embodiments, a depth between the bottom portion and the end point is within a range from 15 μm to 20 μm.

In one of the possible or preferred embodiments, the repeating patterns are further divided into a plurality of first repeating patterns and a plurality of second repeating patterns, and the first repeating patterns and the second repeating patterns are in a staggered arrangement.

In one of the possible or preferred embodiments, a first angle between each of the first repeating patterns and any one of the second repeating patterns that is in line-contact therewith is within a range from 80 degrees to 100 degrees.

In one of the possible or preferred embodiments, a second angle between each of the first repeating patterns and any one of the second repeating patterns that is in point-contact therewith is within a range from 110 degrees to 130 degrees.

In one of the possible or preferred embodiments, the embossed PVC tape includes PVC resin, a plasticizer, and a heat stabilizer.

In one of the possible or preferred embodiments, a content of the PVC resin is 100 parts by weight, a content of the plasticizer is 20 to 40 parts by weight, and a content of the heat stabilizer is 2 to 3 parts by weight.

In one of the possible or preferred embodiments, the embossed PVC tape has a transparency within a range from 90% to 93% and a haze within a range from 1.8% to 2%.

Therefore, in the embossed PVC tape provided by the present disclosure, by virtue of “the embossed texture including a plurality of repeating patterns, each of the repeating patterns including a bottom portion arranged on the first surface and a side portion recessed in the first surface, the side portion having a tapered shape, and an end of the side portion away from the first surface being defined as an end point” and “on the first surface, a quantity of the end point formed per 3,000 square microns being one or more,” the specific anti-sticking property (i.e., the two opposite surfaces of the PVC tape do not easily stick to each other or slide relative to each other) can be possessed without sacrificing the printing quality of the PVC tape.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an embossed PVC tape according to an embodiment of the present disclosure;

FIG. 2 is a schematic top view of the embossed PVC tape according to the embodiment of the present disclosure;

FIG. 3A to FIG. 3C are schematic perspective views of an embossing process of the embossed PVC tape according to the embodiment of the present disclosure;

FIG. 4A to FIG. 4C and FIG. 5A to FIG. 5C are schematic side views of the embossing process of the embossed PVC tape from different perspectives according to the embodiment of the present disclosure; and

FIG. 6 is a schematic perspective view of an embossing mold according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

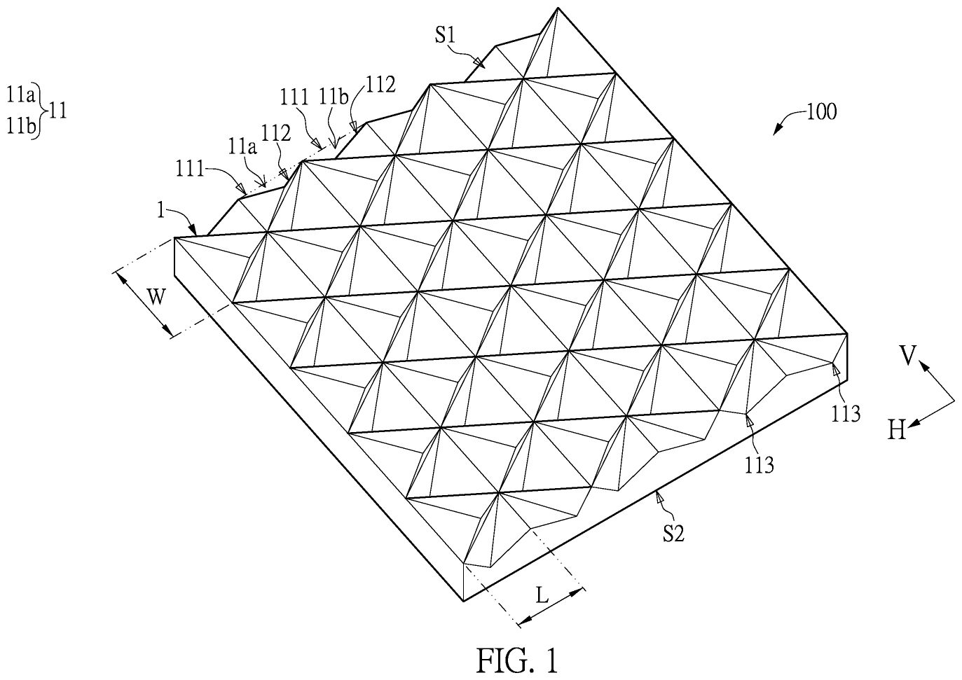

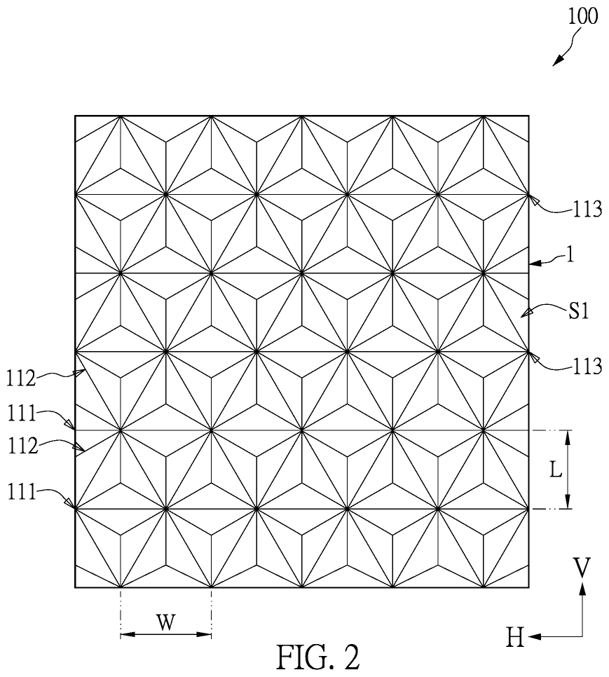

Referring to FIG. 1 and FIG. 2, FIG. 1 is a schematic perspective view of an embossed PVC tape according to an embodiment of the present disclosure, and FIG. 2 is a schematic top view of the embossed PVC tape according to the embodiment of the present disclosure. An embodiment of the present disclosure provides an embossed PVC tape 100. Specifically, the embossed PVC tape 100 has an anti-sticking property. The anti-sticking property can be identified as a property in which different layers of the embossed PVC tape 100 do not easily stick to each other and can be easily detached and printed when being collected into a roll. After being printed, the embossed PVC tape 100 is applicable to table mats, window stickers, and furniture decoration, but the application field of the embossed PVC tape 100 is not limited in the present disclosure.

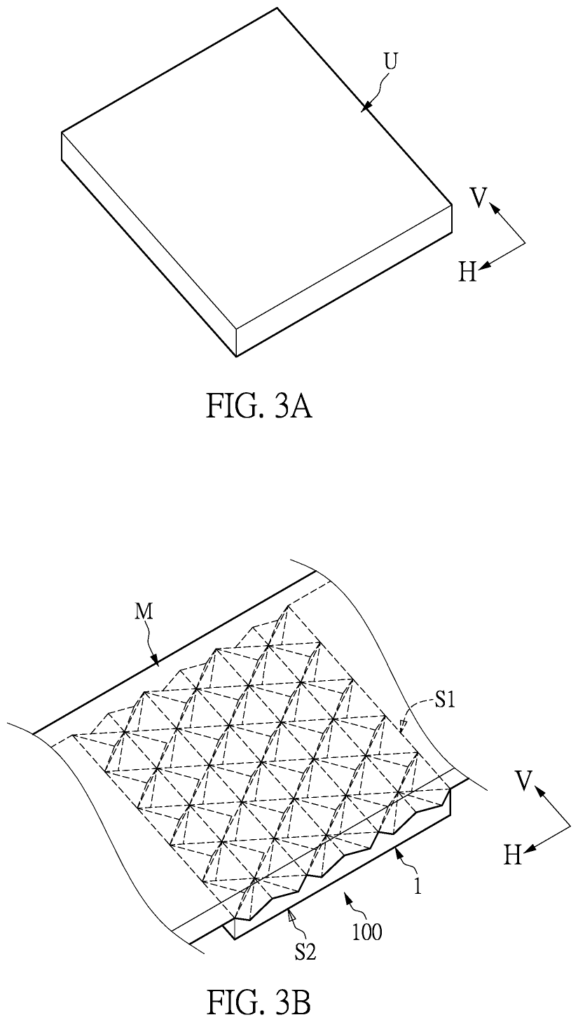

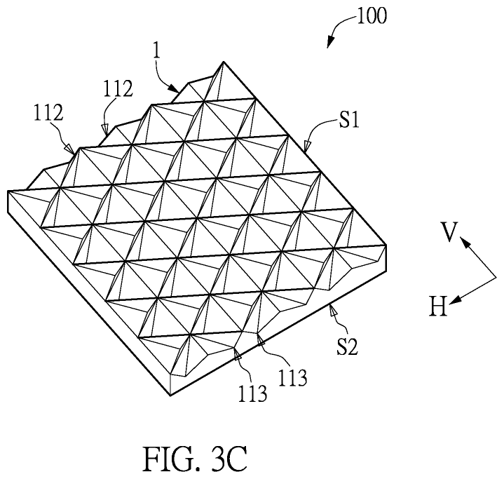

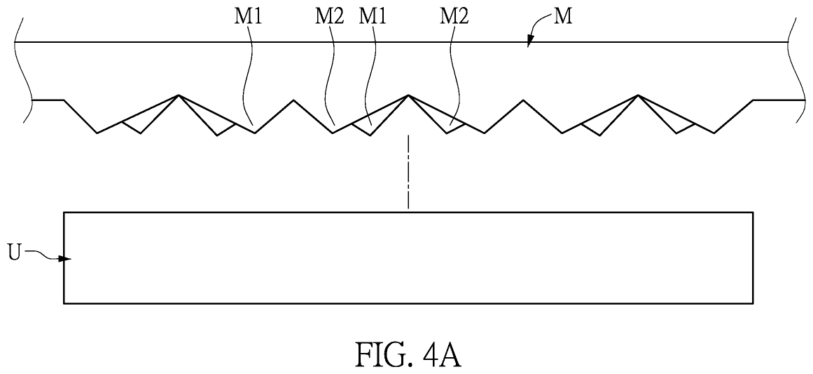

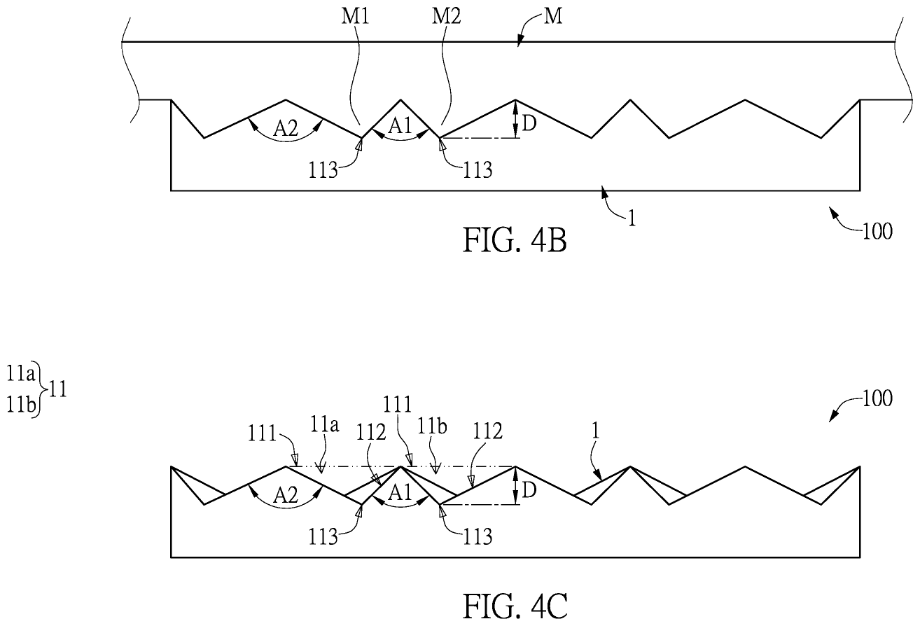

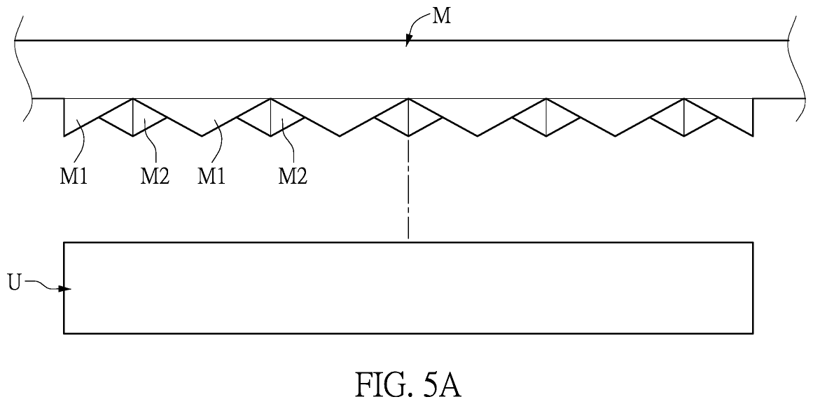

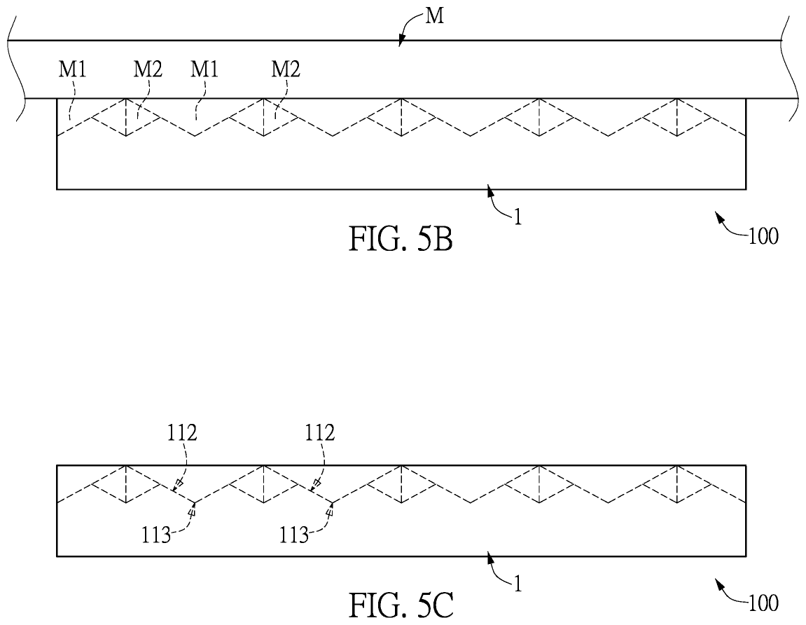

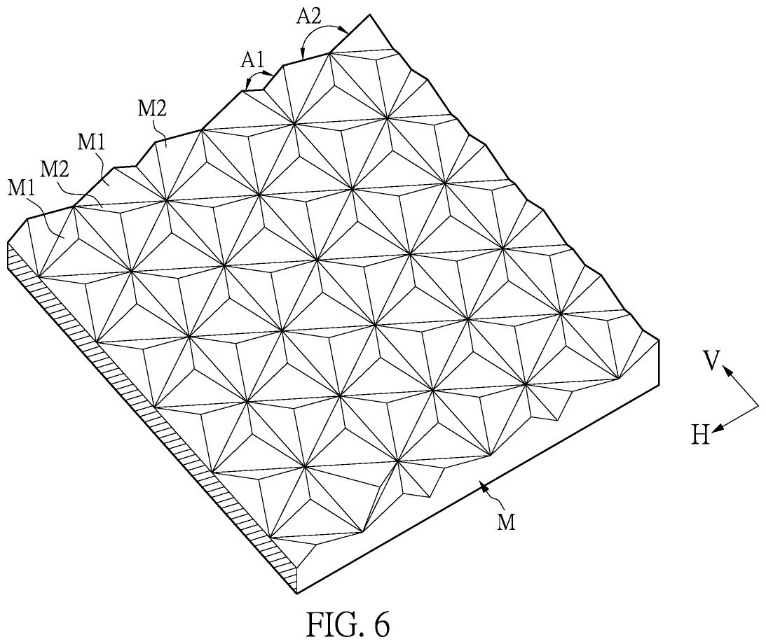

Reference is made to FIG. 3A to FIG. 3C, FIG. 4A to FIG. 4C, FIG. 5A to FIG. 5C, and FIG. 6. FIG. 3A to FIG. 3C are schematic perspective views of an embossing process of the embossed PVC tape according to the embodiment of the present disclosure. FIG. 4A to FIG. 4C and FIG. 5A to FIG. 5C are schematic side views of the embossing process of the embossed PVC tape from different perspectives according to the embodiment of the present disclosure. FIG. 6 is a schematic perspective view of an embossing mold according to the embodiment of the present disclosure.

The embossed PVC tape 100 has a first surface S1 and a second surface S2 respectively defined by two opposite surfaces thereof, and the embossed PVC tape 100 has an embossed texture 1 formed on the first surface S1. The embossed texture 1 can be formed by embossing the first surface S1 with an embossing mold M (i.e., embossing a PVC tape U that has not been embossed). Specifically, the PVC tape U that has not been embossed can first be heated, so as to facilitate the embossing of the first surface S1 with the embossing mold M for formation of the embossed texture 1. After the embossed texture 1 is formed, the embossed PVC tape 100 can be cooled down and collected into a roll.

The embossed texture 1 includes a plurality of repeating patterns 11, and each of the repeating patterns 11 includes a bottom portion 111 arranged on the first surface S1 and a side portion S112 recessed in the first surface S1. The side portion 112 has a tapered shape, and an end of the side portion 112 away from the first surface S1 is defined as an end point 113. On the first surface S1, a quantity of the end point 113 formed per 3,000 square microns is one or more. Accordingly, a maximum static friction coefficient between the first surface S1 and the second surface S2 is within a range from 0.72 to 0.78.

In the present embodiment, the bottom portion 111 has a triangular shape, and the side portion 112 is formed by three surrounding triangles. In other words, in the present embodiment, each of the repeating patterns 11 has a triangular pyramid shape, but the specific structure of the repeating patterns 11 is not limited in the present disclosure. For example, in other embodiments, each of the repeating patterns 11 can have a conical shape, a pyramid shape, or other shapes. In addition, in the present embodiment, one of a plurality of inner angles of the bottom portion 111 is 60 degrees, but the present disclosure is not limited thereto.

In the present embodiment, a length L of the bottom portion 111 along a longitudinal direction V is within a range from 50 μm to 55 μm, a width W of the bottom portion 111 along a lateral direction H is within a range from 58 μm to 62 μm, and a depth D between the bottom portion 111 and the end point 113 is within a range from 15 μm to 20 μm. In other words, an area of the bottom portion 111 of each of the repeating patterns 11 is within a range from 2,900 square microns to 3,410 square microns. Preferably, the length L of the bottom portion 111 along the longitudinal direction V is approximately 52 μm, the width W of the bottom portion 111 along the lateral direction H is approximately 60 μm, and the depth D between the bottom portion 111 and the end point 113 is approximately 17.3 μm.

In the present embodiment, the repeating patterns 11 are further divided into a plurality of first repeating patterns 11a and a plurality of second repeating patterns 11b, and the first repeating patterns 11a and the second repeating patterns 11b are in a staggered arrangement. Specifically, the structure of each of the first repeating patterns 11a is the same as that of any one of the second repeating patterns 11b, and the difference between each of the first repeating patterns 11a and any one of the second repeating patterns 11b is an arrangement angle. In other words, the embossing mold M includes a plurality of first repeating protrusions M1 that are structurally corresponding to the first repeating patterns 11a and a plurality of second repeating protrusions M2 that are structurally corresponding to the second repeating patterns 11b, and each of the first repeating protrusions M1 and each of the second repeating protrusions M2 have a triangular pyramid shape.

It is worth mentioning that, if one of the first repeating patterns 11a is horizontally rotated by 60 degrees, the first repeating patterns 11a can coincide with one of the second repeating patterns 11b. In addition, in the present application, each of the first repeating patterns 11a is surrounded by three of the second repeating patterns 11b.

In the present embodiment, a first angle A1 between each of the first repeating patterns 11a and any one of the second repeating patterns 11b in line-contact therewith is within a range from 80 degrees to 100 degrees, and a second angle A2 between each of the first repeating patterns 11a and any one of the second repeating patterns 11b in point-contact therewith is within a range from 110 degrees to 130 degrees.

Preferably, the first angle A1 between each of the first repeating patterns 11a and any one of the second repeating patterns 11b in line-contact therewith is within a range from 85 degrees to 95 degrees, and the second angle A2 between each of the first repeating patterns 11a and any one of the second repeating patterns 11b in point-contact therewith is within a range from 115 degrees to 125 degrees. More preferably, the first angle A1 between each of the first repeating patterns 11a and any one of the second repeating patterns 11b in line-contact therewith is approximately 90 degrees, and the second angle A2 between each of the first repeating patterns 11a and any one of the second repeating patterns 11b in point-contact therewith is approximately 120 degrees.

It should be noted that, line-contact indicates that one edge of the bottom portion 111 of the first repeating pattern 11a is in contact with one edge of the bottom portion 111 of the second repeating pattern 11b, and point-contact indicates that one end point of the bottom portion 111 of the first repeating pattern 11a is in contact with one end point of the bottom portion 111 of the second repeating pattern 11b.

It is worth mentioning that, on the embossing mold M, an angle between each of the first repeating protrusions M1 and any one of second repeating protrusions M2 that is in line-contact therewith can be regarded as the first angle A1, and an angle between each of the first repeating protrusions M1 and any one of the second repeating protrusions M2 that is in point-contact therewith can be regarded as the second angle A2.

In the present embodiment, the embossed PVC tape 100 includes PVC resin, a plasticizer, and a heat stabilizer. A content of the PVC resin is 100 parts by weight, a content of the plasticizer is 20 to 40 parts by weight, and a content of the heat stabilizer is 2 to 3 parts by weight. In the present embodiment, the plasticizer is selected from the group consisting of dioctyl terephthalate (DOTP), di (2-ethylhexyl) phthalate (DEHP), and di-isononyl phthalate (DINP), and the heat stabilizer is selected from the group consisting of a barium zinc heat stabilizer, a calcium zinc heat stabilizer, and a cadmium barium zinc heat stabilizer.

It is worth mentioning that, as long as the embossed PVC tape 100 can possess the specific maximum static friction coefficient through the embossed texture 1, the specific components of the embossed PVC tape 100 are not limited in the present disclosure. In other embodiments, the embossed PVC tape 100 can also include components other than those mentioned above.

Furthermore, in the present embodiment, the embossed PVC tape 100 can be provided without any lubricant or talcum powder. In other embodiments, the embossed PVC tape 100 can include other components or 0.3 parts by weight to 1 part by weight of a lubricant, and the lubricant can be selected from the group consisting of fatty acid esters, higher fatty acids, fatty amides, and paraffin.

Through the above configurations, the embossed PVC tape 100 has a transparency within a range from 90% to 93% and a haze within a range from 1.8% to 2%. Preferably, the transparency of the embossed PVC tape 100 is approximately 91.3%, and the haze of the embossed PVC tape 100 is approximately 1.9%.

### Experimental Results

PVC tapes that are embossed in different manners are compared with PVC tapes that are not embossed. The transparency, the haze, the anti-sticking property, and the maximum static friction coefficient between the first surface and the second surface are recorded in Table 1 below, and the relevant testing methods are described as follows.

A transparency test is carried out according to STM D1003, in which the PVC tape is hot pressed at 165° C., a test sample has a thickness of 2 mm, and its transparency is measured with a spectrometer (e.g., NDK NDH 7000).

A haze test is carried out according to STM D1003, in which the PVC tape is hot pressed at 165° C., the test sample has a thickness of 2 mm, and its haze is measured with the spectrometer (e.g., NDK NDH 7000).

A maximum static friction coefficient test between the first surface and the second surface is carried out according to ASTM D1894, and a friction analyzer (e.g., CFT-400) is used to measure the maximum static friction coefficient between an embossed surface and a non-embossed surface.

Scoring of the anti-sticking property: a comparison of the PVC tapes shows that the embossed surface and the non-embossed surface of the PVC tape that is embossed with a triangular pyramid texture do not easily stick to each other or slide relative to each other, thereby having a score of 5. Other PVC tapes sequentially have a score of 2 to 4.

TABLE 1
[Test Results of Physical and Chemical Properties of Each PVC Tape]

| | Embossed | | | Non- |
|---|---|---|---|---|
| | (with | | Non- | embossed |
| | triangular | | embossed | (sprinkled |
| | pyramid | Non- | (added with | with talcum |
| Item | texture) | embossed | lubricant) | powders) |
| Transparency of PVC | 91.3 | 91.4 | 90.8 | 89.7 |
| tape (%) | | | | |
| Haze of PVC tape (%) | 1.9 | 1.3 | 2.1 | 4.6 |
| Anti-sticking property | 5 | 2 | 3 | 4 |
| score of PVC tape | | | | |
| Maximum static | 0.76 | 0.94 | 0.87 | 0.77 |
| friction coefficient | | | | |
| between embossed | | | | |
| surface and non- | | | | |
| embossed surface | | | | |

| | | | Embossed |
|---|---|---|---|
| | Embossed | Embossed | (with |
| | (with straight | (with triangular | hexagonal |
| Item | texture) | texture) | texture) |
| Transparency of PVC tape (%) | 90.8 | 91.0 | 91.1 |
| Haze of PVC tape (%) | 3.2 | 3.6 | 4.1 |
| Anti-sticking property score of | 3 | 4 | 4 |
| PVC tape | | | |
| Maximum static friction | 0.89 | 0.84 | 0.79 |
| coefficient between embossed | | | |
| surface and non-embossed | | | |
| surface | | | |

### Discussion of Test Results

The PVC tape embossed with the triangular pyramid texture (i.e., the embossed PVC tape of the present embodiment) has a transparency of 91.3%, a haze of 1.9%, an anti-sticking property score of 5, and a maximum static friction coefficient of 0.76 between the first surface and the second surface.

The non-embossed PVC tape has a transparency of 91.4%, a haze of 1.3%, an anti-sticking property score of 2, and a maximum static friction coefficient between the first surface and the second surface of 0.94. The non-embossed PVC tape added with the lubricant has the transparency of 90.8%, a haze of 2.1%, an anti-sticking property score of 3, and a maximum static friction coefficient between the first surface and the second surface of 0.87. The non-embossed PVC tape sprinkled with the talcum powders has a transparency of 89.7%, a haze of 4.6%, an anti-sticking property score of 4, and the maximum static friction coefficient between the first surface and the second surface of 0.77.

The PVC tape embossed with straight texture has a transparency of 90.8%, a haze of 3.2%, an anti-sticking property score of 3, and a maximum static friction coefficient between the first surface and the second surface of 0.89. The PVC tape embossed with triangular texture has a transparency of 91%, a haze of 3.6%, an anti-sticking property score of 4, and a maximum static friction coefficient between the first surface and the second surface of 0.84. The PVC tape embossed with hexagonal texture has a transparency of 91.1%, a haze of 4.1%, an anti-sticking property score of 4, and a maximum static friction coefficient between the first surface and the second surface of 0.79.

It is worth mentioning that, preferably, the maximum static friction coefficient between the first surface and the second surface of the PVC tape is approximately 0.76. If the maximum static friction coefficient between the first surface and the second surface is too high, different layers of the PVC tape may easily stick to each other and cannot be easily detached when being collected into a roll. In contrast, if the maximum static friction coefficient between the first surface and the second surface is too low, different layers of the PVC tape may easily slide relative to each other when being collected into a roll.

### Beneficial Effects of the Embodiment

In conclusion, in the embossed PVC tape provided by the present disclosure, by virtue of “the embossed texture including a plurality of repeating patterns, each of the repeating patterns including a bottom portion arranged on the first surface and a side portion recessed in the first surface, the side portion having a tapered shape, and an end of the side portion away from the first surface being defined as an end point” and “on the first surface, a quantity of the end point formed per 3,000 square microns being one or more,” the specific anti-sticking property (i.e., the two opposite surfaces of the PVC tape do not easily stick to each other or slide relative to each other) can be possessed without sacrificing the printing quality of the PVC tape.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An embossed PVC tape, comprising:
a first surface and a second surface that are opposite to each other;
wherein the embossed PVC tape has an embossed texture formed on the first surface;
wherein the embossed texture includes a plurality of repeating patterns, each of the repeating patterns includes a bottom portion arranged on the first surface and a side portion recessed in the first surface, the side portion has a tapered shape, and an end of the side portion away from the first surface is defined as an end point;
wherein, on the first surface, a quantity of the end point formed per 3,000 square microns is one or more;
wherein a maximum static friction coefficient between the first surface and the second surface is within a range from 0.72 to 0.78.

2. The embossed PVC tape according to claim 1, wherein each of the repeating patterns has a triangular pyramid shape.

3. The embossed PVC tape according to claim 1, wherein a length of the bottom portion along a longitudinal direction is within a range from 50 μm to 55 μm, and a width of the bottom portion along a lateral direction is within a range from 58 μm to 62 μm.

4. The embossed PVC tape according to claim 1, wherein a depth between the bottom portion and the end point is within a range from 15 μm to 20 μm.

5. The embossed PVC tape according to claim 1, wherein the repeating patterns are further divided into a plurality of first repeating patterns and a plurality of second repeating patterns, and the first repeating patterns and the second repeating patterns are in a staggered arrangement.

6. The embossed PVC tape according to claim 5, wherein a first angle between each of the first repeating patterns and any one of the second repeating patterns that is in line-contact therewith is within a range from 80 degrees to 100 degrees.

7. The embossed PVC tape according to claim 5, wherein a second angle between each of the first repeating patterns and any one of the second repeating patterns that is in point-contact therewith is within a range from 110 degrees to 130 degrees.

8. The embossed PVC tape according to claim 1, wherein the embossed PVC tape includes PVC resin, a plasticizer, and a heat stabilizer.

9. The embossed PVC tape according to claim 8, wherein a content of the PVC resin is 100 parts by weight, a content of the plasticizer is 20 to 40 parts by weight, and a content of the heat stabilizer is 2 to 3 parts by weight.

10. The embossed PVC tape according to claim 1, wherein the embossed PVC tape has a transparency within a range from 90% to 93% and a haze within a range from 1.8% to 2%.
